(19) United States
(12) Patent Application Publication
(10) Pub. No.: US 2014/0243716 A1
(43) Pub. Date: Aug. 28, 2014

(54) Limb Support Device

(71) Applicant: The Provost, Fellows, Foundation Scholars, & the Other Members of Board, of The College of the Holy, Dublin 2 (IE)

(72) Inventors: Lucile Diot, Lugrin (FR); Kevin Daulnay, Dublin, 3 (IE); Liam Breen, Limerick (IE)

(21) Appl. No.: 14/347,790

(22) PCT Filed: Sep. 27, 2012
(86) PCT No.: PCT/EP2012/069053

§ 371 Date: Mar. 27, 2014

(30) Foreign Application Priority Data
Sep. 27, 2011 (GB) 1116611.3
May 11, 2012 (EP) 12167754.6

(51) Int. Cl. A61H 1/02

(52) U.S. Cl. CPC A61H 1/02
USPC 601/5

(57) ABSTRACT

A limb support device for supporting a limb of a patient, the limb including an upper limb above a joint and a lower limb below the joint, the device having an upper limb support for supporting the upper limb but not the lower limb, so that the lower limb can articulate about the joint when the upper limb is being supported by the upper limb support. A lower limb support is arranged for engaging the lower limb only, and for raising and lowering the lower limb by articulation about the joint, so that, while the upper limb is supported by the first part, the second part is moveable between a position where it is remote from the lower limb and a position in which it engages the lower limb.

### FIELD OF THE INVENTION

The present invention relates to a limb support device for supporting the limb of a patient. In particular the present invention relates to a limb support device which is for raising and lowering the limb of a patient.

### BACKGROUND TO THE INVENTION

Many devices for lifting are known. In the field of health care there are many devices for lifting entire patients and/or transferring them. The present invention is particularly concerned with devices that are suitable for supporting at least one limb of a patient.

In the medical field is often necessary to raise part of a patient's body, for example one limb. This may be done to raise the limb above a surface. For example if the patient is seated or lying on a given surface then it may be desirable to raise a limb from that surface. So, for example when a patient is lying or seated, it may be desirable to raise a limb, such as a leg, to allow access thereto for treatment thereof.

Such instances arise where it is desirable to wash the limb, apply a preparation thereto and/or apply a covering, for example a bandage or cast, about the limb. In the case of certain patients, for example those who have excessive fluid in one or more limbs of the body, it is often desirable to apply a pressure bandage to a limb to facilitate reduced swelling. Such a bandage is often applied by continuous wrapping about the limb, for example in the case of a leg, from the foot upwards towards the knee. In order to have ease of access about the limb it is desirable to have the limb in a raised position. Often times the person applying the bandage, such as a caregiver has to manually grip and lift the limb in question. It is difficult to do so whilst trying to treat the limb, for example whilst applying a bandage. Furthermore, for people with severe conditions, the amount of fluid can be high and thus the overall weight of the leg, can be great. This makes it difficult for the caregiver to lift the leg. Furthermore it is not practical to ask the patient to raise the limb and hold it in a raised position even for short intervals because it is simply too difficult for them to lift the limb or maintain it in a raised position using their muscles.

The present invention is aimed at alleviating the problems of handling the limbs of patients and in particular those that are larger and heavier than normal.

UK Patent No. GB 112,238 describes an adjustable leg support which is used in surgery for supporting a limb and for dressing and other operations. It has a leg-receiving bracket on a height adjustable pole and a base that can be attached to a bed or the like. Similar devices are shown in German Patent Application DE 10 2010 007 334 and Swedish Patent Publication SE 0900379. Such devices are typically only suited for holding a limb in a predetermined raised position.

US patent publication number US 2008/0276375 describes an appendage elevation system. It has two parts. It has an upper leg platform which is for supporting the upper leg, and it has a lower leg support frame for supporting the lower leg. The angle between the upper leg support portion and the lower leg support frame can be adjusted. A foot support portion is provided on the lower leg support frame. Similar devices are disclosed in US patent publication number US 2004/0059268 and Dutch Patent Publication No. 242 (application no. 493 from 20 Jun. 1912), U.S. Pat. No. 7,381,172B, and U.S. Pat. No. 3,717,144, European patent publication No. EP 0, 074, 334, French Patent Publication FR 2 770 997. Even with a device such as these it is difficult to place a cover, such as a bandage or cast on the leg.

US patent publication number US 2006/0042011 describes a series of leg supports for the end of a surgical table for adjusting the relative position and angles of the legs of a patient. With this device too, it is difficult to treat a limb, for example it is difficult to place a cover, such as a bandage or cast on the leg. Other assorted devices include US patent publication number US 2006/272893 to an adjustable limb support, US patent publication number US 2010/125125947 to a device for moving legs on or off a bed, UK patent publication number GB 2,450,894, to an apparatus for lifting the heel of a seated user, German patent publication number DE 4442039 for lifting the legs of a patient lying down and International patent publication number WO 2005/067859 describes a device with two height adjustable brackets for holding legs in a raised position.

UK Patent Publication No. GB 2 344 764 describes a limb support device which incorporate a basin. The device has a limb support designed mainly to support the upper leg. The basin is for collecting fluid that weeps from the leg as a bandage is applied. The device is cumbersome with the basin and is fixed so that the angle of the leg cannot be changed. Furthermore it is thought it would be uncomfortable for the patient as there would be a lot of pressure about the knee joint.

International Patent Publication No. WO 93/09735 describes a device which is for dressing a leg or immobilising the lower leg. It has a planar support on which the patient lies. It has a second upright angled support against which the foot of the patient may rest to hold the leg in a bent position, or which can be moved to a position underneath the knee so as to hold the lower leg in a raised position. The device is not directed to solving the issue is set out above. In particular it will be difficult to change the device between the position in which it supports the foot and the position in which it acts as a support underneath the knee, and in particular for those patients suffering from inflammation of the leg.

Notwithstanding the devices described above it is desirable to provide an alternative device, which is easy to use.

### SUMMARY OF THE INVENTION

In one aspect, the present invention provides a limb support device for supporting a limb of a patient, the limb including an upper limb above a joint and a lower limb below the joint, the device comprising:
a first part for supporting the upper limb but not the lower limb, so that the lower limb can articulate about the joint when the upper limb is being supported by the first part;
a second part arranged for engaging the lower limb only, and for raising and lowering the lower limb by articulation about the joint, so that, while the upper limb is supported by the first part, the second part is moveable between a position where it is remote from the lower limb and a position in which it engages the lower limb.

The device of the invention is particularly suited for engaging a limb for raising the limb from a surface on which it rests. So for example where the limb is a leg the device of the invention can be actuated to raise the lower leg, for example by articulation about the knee. This means that a patient's foot, and in particular the heel of the foot can be lifted clear of the surface for treatment thereof. For example where a bandage such as a pressure bandage is to be applied, the bandage can be applied to the raised foot and then continued progressively upwardly along the leg. The application of the bandage is hands free insofar as the caregiver does not have to hold any part of the limb to keep it in the raised position. Both hands of the caregiver are thus free for application of the bandage. This represents a distinct and advantageous method of raising a limb as compared to prior art devices.

Once the treatment, such as the bandage application, has progressed sufficiently far up the limb, the limb can then be lowered by moving the second part to a position where it is remote from the limb. In this context remote means sufficiently remote to allow a treatment to be given to the lower limb without the device interfering with access to the limb. The device will thus lower the limb and then move out of contact with the limb. The weight of the limb, for example the leg can once again be taken up by the surface and because the bandage is already applied to a part of the limb, for example leg this does not represent an issue. Furthermore because the second part is remote from the limb it does not interfere with continued treatment of the limb, for example continued application of a bandage.

It will be appreciated that the first part of the device is intended to support the limb in a position where the limb is bent about the joint, for example where a leg or arm is a bended position in a rest position (in which position the second part is not in contact with the lower limb). This means that the limb is held in an angled position so that the lower limb can be raised by articulation about the joint but without the necessity to move the upper limb. Desirably the angled position is an elevated (raised) position of the upper limb. Such a raised position is typically achieved by articulation about a joint such as the shoulder or hip joint.

Desirably then the device of the invention has a configuration, in use, where the upper limb is supported by the first part, the limb is bent (angled) about the joint, and the lower limb is resting on a surface and where the second part is out of contact with the lower limb (it is remote therefrom at a sufficient distance) to allow treatment of the lower limb.

The second part can then be used to raise the lower limb by articulation about the joint, typically by unbending the limb toward its straightened position.

Desirably the second part engages the lower limb only at an upper region thereof. This means there is minimum interference with any treatment of the limb. (In this respect “upper” relates to a region closer to the joint with the upper limb.)

Suitably the upper limb support is moveable between a raised and lowered position. This means that it may be easier to place the device underneath the limb of a patient for support thereof.

The second part may be carried on the first part. This is a very simple, yet effective arrangement, as the second part can extend from the first part to engage and elevate the lower limb, yet retract, when desired, to prevent it interfering with the treatment procedure. In particular it means that the second part does not independently engage with a support surface—it is supported through the first part.

In the remote position the second part may be closer to the first part, and in the position where it engages the lower limb, it may extend further away from the first part. Again this allows for a simple yet highly effective arrangement.

Suitably the device further comprises an actuator for moving the second part to raise the lower limb. Use of an actuator is desirable as this allows the lifting of the lower limb to be done by the actuator.

In one embodiment at least one movement of the actuator of the second part may cause the first part to rise. For example the movement of the actuator may cause the second part to engage a part of (, for example the base of) the device, and/or a support surface on which the device sits and then raise the first part. For example the actuator for the second part may cause the second part to pivot in a direction toward the underneath of the first part (, for example a fold under type action,) and cause the first part to rise. Such an action of the actuator may be effected by a shortening action of the actuator, for example a shortening of a telescopic actuator. Utilising this action a user can get the upper limb into a desired position. Desirably the first part is releasably fixable in that position, so that the actuator for the second part can then be utilised to raise the lower limb. Such an arrangement obviates the necessity to have a second actuator for the first part.

The device may further comprise an actuator for moving the first part to raise the upper limb. The device of the invention can then raise the upper limb too, and independently of the first actuator.

Actuators are not required, for example one or both of the first and second parts may be moved manually to a desired position and then held in that position by any suitable mechanism. Where an actuator is used it may comprise an extendable piston arrangement for example a telescopic cylinder.

Desirably the device of the invention is adjustable within its range of movements so that the relative angle of the lower limb to the upper limb (and indeed the angle of each also to the torso of the user) can be adjusted.

Desirably, the device is adjustable to accommodate different sizes of patient. For example the device of the invention may be utilised in a treatment for patients of varying heights. Generally speaking taller patients will have longer limbs and in general children will be shorter than adults. According to one embodiment of the invention the position of the second part is adjustable for limbs of different length. For example the distance between the second part and the first part may be lengthened to accommodate a relatively longer limb and may be shortened to accommodate a relatively shorter limb. This means that the second part can be adjusted to abut and lift a lower limb at a desirable position along that limb to take account of longer and shorter limbs. For example the second part may be adjusted so as to be a greater or shorter distance away from the first part when the second part is in a position in which it is engaged with the limb. Where the second part is carried on the first the second part may be adjusted to be a desired distance from the first part when the second part is in the lower limb lifting configuration. The configuration can be chosen to suit the length of the limb.

Suitably the device of the invention has a substantially flat configuration where the first and second parts are arranged to allow a limb to lie substantially along the device. This makes it easier to get the device in position under a patient who is lying down. In such a position the limb may be in a straight or substantially straight position.

Desirably both the first and second parts are padded for patient comfort. In one arrangement the first and second parts from a substantially continuous support surface for the limb, for example a substantially continuous support cushion. Desirably a support surface thereof is curved.

The device may further comprise a portion which is arranged so that in use, it can extend underneath the torso of a patient, for example underneath the buttocks of the patient. The device may comprise a protective enclosure for enclosing any moving parts so that they don't catch/pinch anything when moving.

In a desirable arrangement, which helps to prevent unwanted movement of the device, the device of the invention is desirably fitted with non-slip means for example non-sip material for engaging a support on which the device is placed. For example the non-slip material may be a high friction material. Suitable materials are well-known and include elastomers such as rubber. The non-slip material may be provided in the form of a single non-slip pad or alternatively may be provided in the form of at least two discrete pads which are spaced apart from each other. The non-slip means may have a physical non-slip profile, for example having raised ribs and/or threads.

In one arrangement a device of the invention is recessed into a patient support such as a seat, bed or table. In such an arrangement the device of the invention may, have a configuration where it is arranged to be substantially flush with a support surface of the patient support, for example substantially flush with the upper surface of a pad, mattress, or the like of the patient support. In one embodiment the device of the invention may be incorporated into any patient support which is suitable for supporting the patient during a treatment, for example incorporated into a seat, examination table or bed.

The invention relates to an adjustable limb support device comprised of a support frame and independently actuated limb supports, said adjustable limb support device manipulating the limb such that where a carer is applying a bandage to a limb both hands of the carer are free during the entire process.

The invention relates to a device that has at least the following three configurations: (i) a low profile configuration which is desirably a substantially flat configuration; (ii) a first raised profile configuration where both the upper limb and lower limb are held in a raised position and (iii) a second raised profile configuration where only the upper limb is held in a raised position by the device and the lower limb is free to articulate about its joint so that its lower end can support itself. For example with a leg the device of the invention has (i) a low profile configuration where it fits under a leg and desirably the leg is substantially straight; (ii) a first raised profile configuration where both the upper leg (above the knee) and lower leg (below the knee) are held in a raised position so that the foot is in the air; and (iii) a second raised profile configuration where only the upper leg (above the knee) is held in a raised position by the device and the lower leg (below the knee) is free to articulate about the knee so that the foot, for example the heel thereof, can support the lower leg.

A system of the invention comprises the device of the device of the invention together with a control system therefore, the control system for effecting movement for example pre-programmed movement within a limb raising sequence of movements.

Desirably the control system is for effecting pre-programmed movement within a limb raising and lowering sequence of movement.

The control system may be automated to carry out pre-programmed movement in a stepwise fashion in response to input signals generated by action of a user.

The control system of the invention may be operably by using an input device which does not require the use of the hands of a user. For example one or more foot activated input devices such as one or more foot pedals may be utilised.

The invention extends to a device and system as described herein with reference to and as illustrated in the accompanying drawings.

### BRIEF DESCRIPTION OF THE DRAWINGS

Embodiments of the invention will be described, by way of example only, with reference to the accompanying drawings in which:

FIG. 1 is a side view of a schematic representation of a device of the invention in place beneath and supporting a limb (leg) of a patient;

FIG. 2 is a side view similar to FIG. 1 with both the upper and lower limbs the limb (leg) of a patient raised by the device;

FIG. 3 is a side view similar to FIG. 1 with the upper a limb (leg) of a patient raised by the device and with the device out of contact with the lower limb;

FIG. 4 is a side view of the device of FIG. 1 returned to the configuration of FIG. 2 with the limb of a patient raised once again;

FIG. 5 is a side view of the device of FIG. 1 returned to the configuration of FIG. 1;

FIG. 6 is a side view of an alternative device of the invention similar to that of FIGS. 1 to 5, and in a raised configuration;

FIG. 7 is a side view of the device of FIG. 6 in a lowered configuration;

FIG. 8 is a side view of the device of FIG. 7 in a raised configuration but with the lower limb support retracted;

FIG. 9 is a perspective view of a further alternative device of the invention similar to that of FIGS. 1 to 5, and in a raised configuration;

FIG. 10 shows a schematic representation of a device of the invention incorporated into a patient support ;

FIG. 11 is a side view of the device of the invention which is adjustable to accommodate different limb lengths.

### DETAILED DESCRIPTION OF THE DRAWINGS

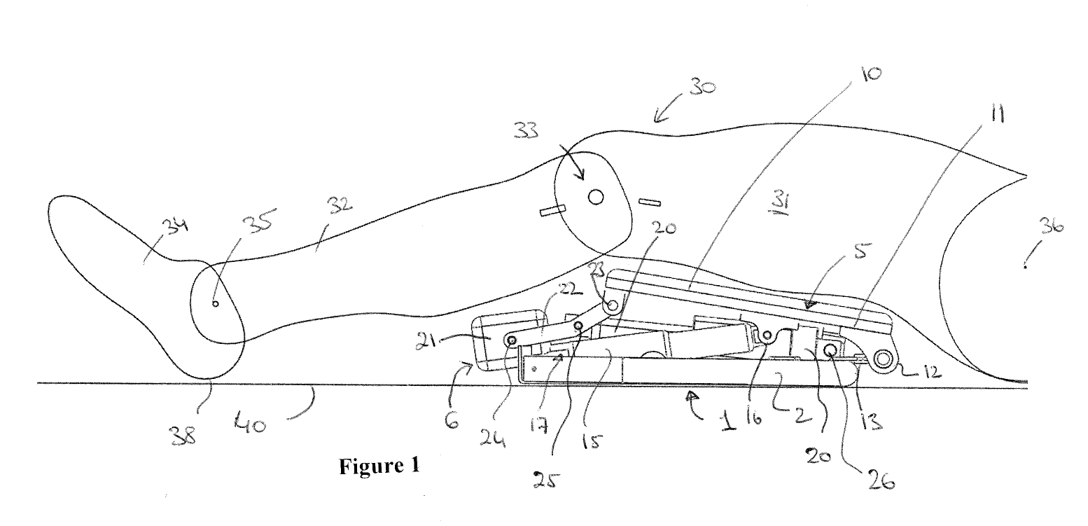

FIGS. 1 to 5 show a series of configurations of a device 1 of the invention which are useful for the treatment of the limb of a patient. The device 1 may be cycled through these configurations in the order shown.

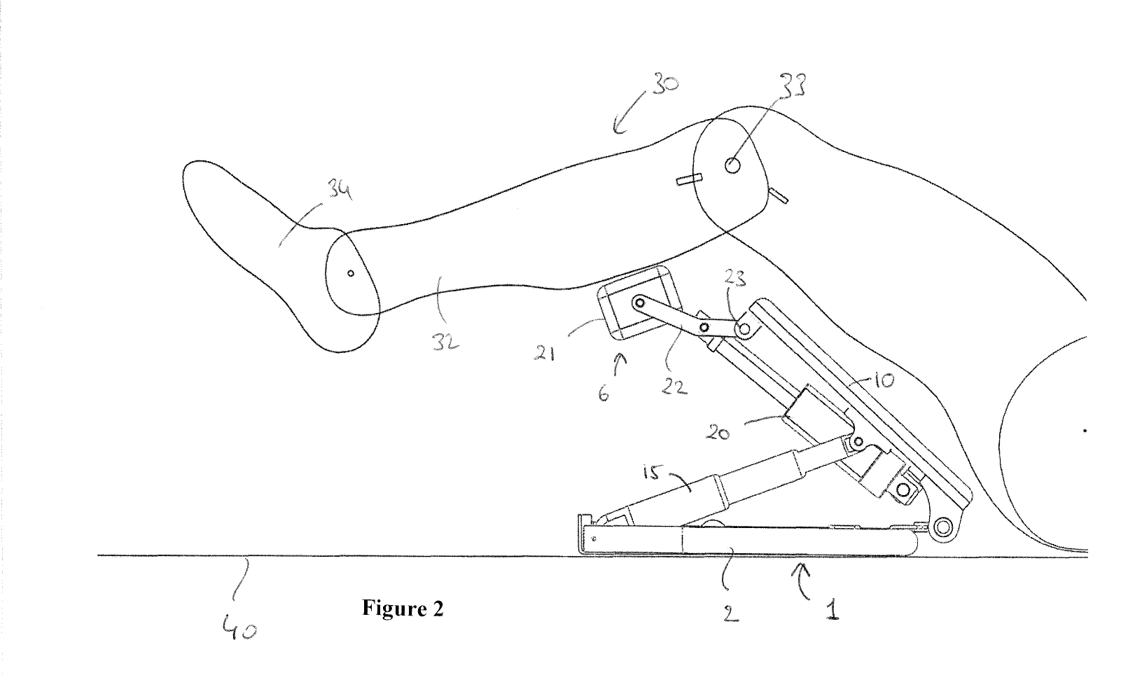

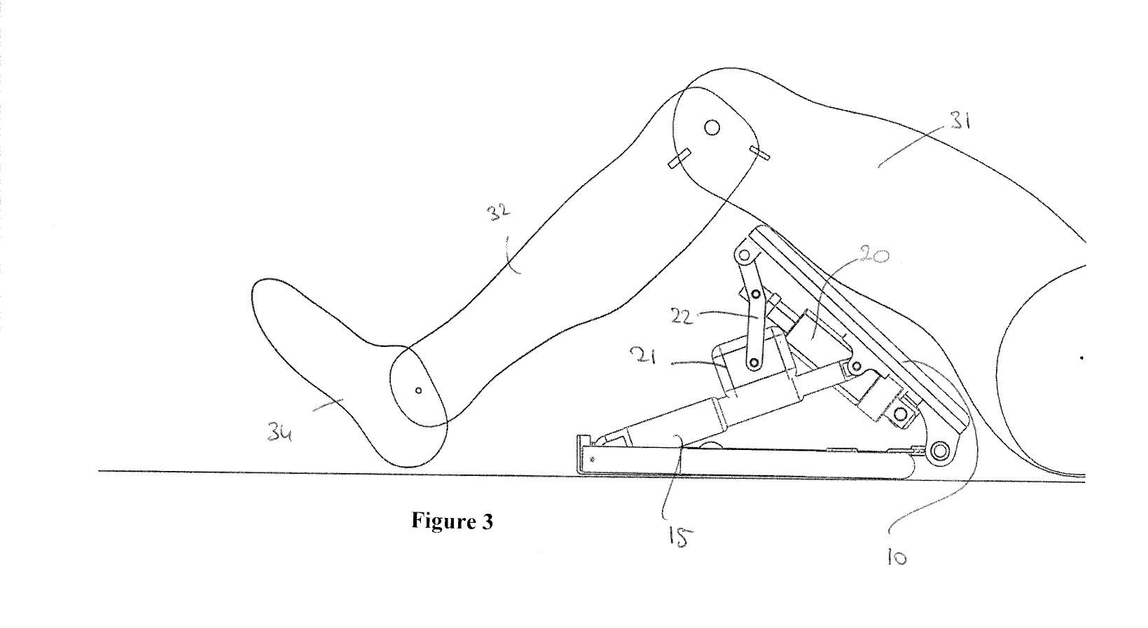

The drawings show a limb support device for supporting a limb of a patient the limb including an upper limb above a joint and a lower limb below the joint. The device has at least the following three configurations:
(i) a low profile configuration (FIG. 1);
(ii) a first raised profile configuration where both the upper limb and lower limb are held in a raised position (FIG. 2); and
(iii) a second raised profile configuration where only the upper limb is held in a raised position (FIG. 3) by the device and the lower limb is free to articulate about its joint so that a lower end of the lower limb can support the lower limb.

The invention provides a limb support device 1 for supporting a limb 30 of a patient (the torso of the patient is omitted for ease of illustration).

The limb 30 an upper limb or thigh portion 31 above a joint, in particular knee joint 33 and a lower limb 32 below the joint 33. Also schematically shown on the limb 30 are a foot 34 an ankle joint 35 and a hip joint 36. In the Figures the patient is shown in a reclined, and in particular a lying position. The patient and the device 1 are on a supporting surface 40.

The device 1 has a first part for supporting the upper limb 31 in the form of an upper limb support 5. The upper limb support 5 does not extend underneath (support) the lower limb 3. Whilst upper limb 31 is supported by the upper limb support 5 the lower limb 32 can articulate about the knee joint 33.

The device 1 has a second part in the form of lower limb support 6. The lower limb support 6 is arranged for engaging the lower limb 32 only, and for raising and lowering the lower limb 32 by articulation about the knee joint 33, so that, whilst the upper limb 31 is supported by the upper limb support 5, the lower limb support 6 is moveable between position where it engages the lower limb 32 (see FIG. 2) and a position in which it is remote from the lower limb 32 (see FIG. 3).

These independently selectable configurations of the device 1 allow for its usefulness and versatility.

The device 1 of the invention is particularly suited for engaging the leg 30 for raising the leg from a surface 40 on which it rests. The device 1 can be actuated to raise the lower leg 32, for example by articulation about the knee as shown in FIG. 2. This means that the patient's foot 34, and in particular the heel 38 of the foot 34, can be lifted clear of the surface 40 for treatment thereof. For example where a bandage (not shown) such as a pressure bandage is to be applied, the bandage can be applied to the raised foot 34 (in the configuration of FIG. 2) and then continued progressively upwardly along the leg. The application of the bandage is hands free insofar as the caregiver does not have to hold any part of the limb to keep it in the raised position. Both hands of the caregiver are thus free for application of the bandage. This represents a distinct and advantageous method of raising a limb as compared to prior art devices.

Once the treatment, such as the bandage application, has progressed sufficiently far up the lower limb 32, the lower limb 32 can then be lowered (from the position of FIG. 2 to that of FIG. 3) by moving the lower limb support 6 to a position where it is remote from the limb 30. The device 1 will thus lower the lower limb 32 and then move out of contact with the limb. The weight of the leg 30 can once again be taken up by the surface 40, because the foot 34 and in particular the heel 38 thereof is supported again by surface 40. Because the bandage has already been applied to the foot/heel and lower part of the lower limb this does not represent an issue. Furthermore because the lower limb support 6 is remote from the limb 30 it does not interfere with continued treatment of the limb 30, for example continued application of a bandage.

In such an arrangement the limb can be treated up to at least the joint thereof without the device 1 of the invention forming an obstacle to the treatment. This is a major advantage of the device of the invention as compared to prior art devices.

The lower leg support 6 engages the underside of lower limb 32 only at an upper region thereof (close to the knee joint 33). This means there is minimum interference with any treatment of the limb.

The upper limb support 5 is moveable between a raised (FIG. 2) and lowered (FIG. 1) position. This means that it may be easier to place the device 1 underneath the limb 30 of a patient for support thereof as shown in FIG. 1. In particular FIG. 1 shows a substantially flat configuration of the device of the invention which is easy to place underneath the limb of a patient.

In more detail the device 1 comprises a stand portion 2 which is for supporting the device 1 on a support surface such as surface 40. The upper limb support 6 comprises a limb support pad 10 on which a limb 30 can rest. A support frame 11 carries the pad 10 and is in turn pivotally mounted by a hinge mechanism 12 and bracket 13 onto stand 2.

An actuator in the form of a telescopically extensible arm 15 is coupled between the support frame 11 (at bracket 16) and the stand portion 2 (at bracket 17). Extension of the arm 15 raises the support pad 10. Retraction of the arm 15 lowers the support pad 10.

In the embodiment the lower limb support 6 is carried on, and by, the upper limb support 5. In particular the lower limb support 6 comprises a pad 21 carried on arms 22 which in turn are attached by a pivotal arrangement 23 to support frame 11 of the upper limb support 5. The pad 21 is pivotable about axis 24 so that the orientation of the pad 21 can change for the comfort of the patient. An actuator in the form of an extensible arm 20 is also carried by the upper limb support 5 and is coupled between the pivot point 25 (on the arms 22) and the pivot point 26 on support frame 11. Extension of the arm 20 raises the support pad 21 (and in turn the lower limb as in FIG. 2). Retraction of the arm 15 firstly lowers the lower limb and then moves the pad 21 into a position where it is remote from the lower limb (as seen in FIG. 3). In particular it pivots to a position below the upper limb support 10. This makes for a compact arrangement which does not interfere with treatment for example bandaging of a limb.

In one arrangement at least one movement of the arm 15 causes the upper limb support 5 to rise. For example the movement of the arm may cause the pad 21 or arms 22 of the lower limb support to engage the base of the device 1, for example the stand 2 thereof, and/or the support surface 40 on which the device sits and then raise the upper limb support 5. For example causing the lower limb support 6 to pivot in a direction toward the underneath of the upper limb support 5 (as shown in the movement from the position in FIG. 2 to the position in FIG. 3), when the device is in a low profile position (as shown in FIG. 1) and thus cause the upper limb support 5 to rise. Such an action of the actuator may be effected by a shortening action of the arm 5. Utilising this action a user can get the upper limb 31 into a desired position. Desirably the upper limb support 5 is releasably fixable in that position, so that the actuator for the second part can then be utilised to raise the lower limb 30. Such an arrangement obviates the necessity to have a separate actuator for the upper limb support 5.

The actuators 15,20 are independently operable. It will be appreciated that any angle of the limb support 10 or the support pad 21 may be selected by extending or retracting the actuators 15, 20 to any desired relative position.

The sequence of operation is very simple. Firstly the device 1 is placed beneath the limb 30 as shown in FIG. 1. The limb 30 is then raised using one or both actuators 15, 20. A typical raised position is shown in FIG. 2. It will be appreciated that in the position of FIG. 2 the foot 24 and lower limb 32 are raised from the support surface 40 and can be treated, for example have a bandage applied, without any interference from the device 1 of the invention. It will also be appreciated that the lower limb support 6 operates by raising the lower limb 32 about the limb joint 33 by pushing the limb from behind (the underside) of the limb. Furthermore, because the limb support 6 engages or obstructs only a relatively small portion of the limb (less than one third of the lower limb), it leaves a substantial proportion of the lower limb free for treatment. When the lower limb 32 has been treated beyond the foot 34, the lower limb support 6 can be retracted by operation of actuator 20 (for example to the position shown in FIG. 3). In this position the upper limb 31 is still supported by the upper limb support 5. The lower limb support 6 however it is now remote from the lower limb 32 and the limb rests naturally on the support surface 40. As can be seen the device 1 of the invention, and in particular the lower limb support 6, is remote from the lower limb 32. This means that treatment of the limb to at least the joint 33 can be continued without any interference from the device 1 whilst the device 1 is still in place. In particular there is room for a caregiver to access the underside of the limb with their hands without interference from the device 1.

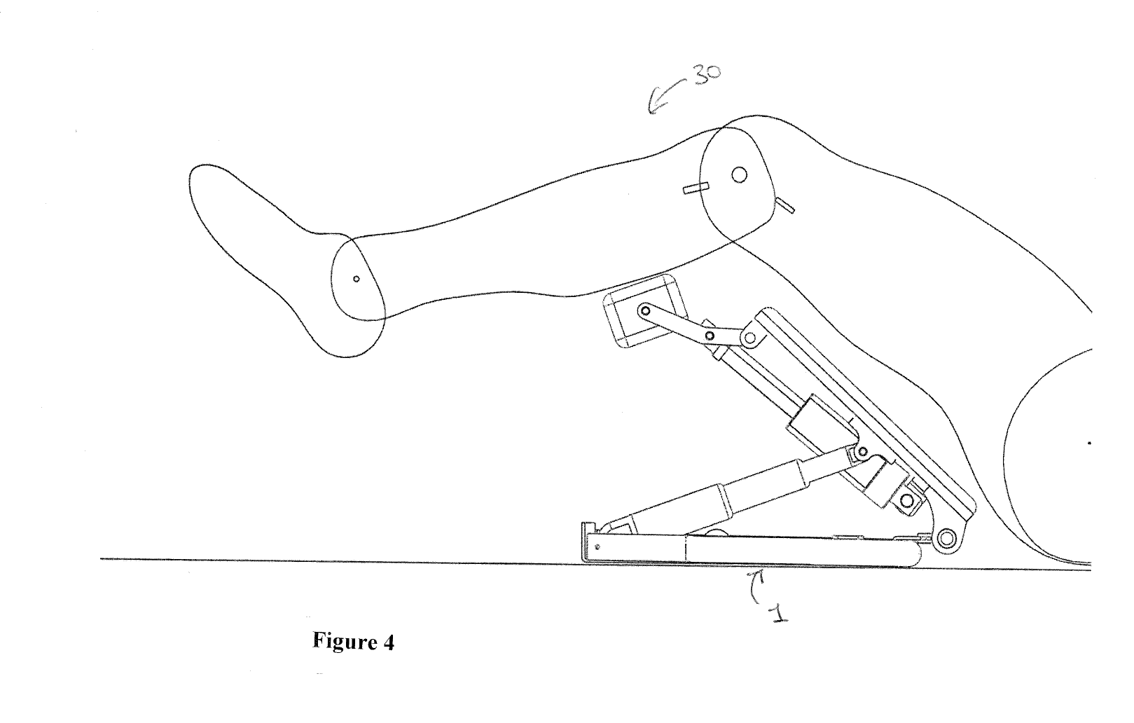

FIG. 4 shows the limb raised once again for treatment, for example as may be desired, such as if it is desired to repeat treatment of the limb, for example apply a second bandage thereto. Once the further treatment is carried out the elevated limb 30 can be lowered once more to the position shown in FIG. 5. In the position of FIG. 5 the device is back in the configuration of FIG. 1. The device is more easily removed from beneath a patient in this configuration. It will be appreciated that the raising and lowering of the limb can be carried out as many times as is desired for a given treatment, for example a repeated treatment.

It will be appreciated that the device 1 of the invention is suitable for raising a limb to any desired position within a range of positions for treatment.

It is desirable that the invention also includes a control system of the type which can control the movement of the device. For example the control system may be for effecting movement for example pre-programmed movement within a limb raising and lowering sequence of movements.

The control system is for effecting pre-programmed movement within a limb raising and lowering sequence of movement. For example one or more of the positions shown in FIGS. 1-5 may be pre-programmed into the device and each position initiated by a single action from the user. In this way the control system may be automated to carry out pre-programmed movement in a stepwise fashion in response to input signals generated by action of a user.

The control system of the invention may be operable by using an input device which does not require the use of the hands of a user. For example one or more foot activated input devices such as one or more foot pedals may be utilised. This allows the caregiver to keep their hands free for treatment of the limb.

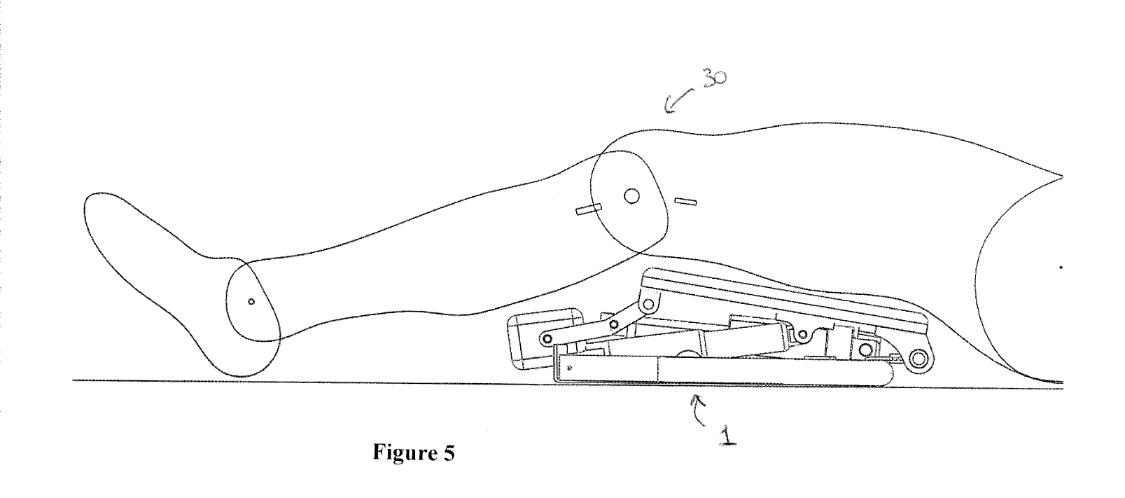

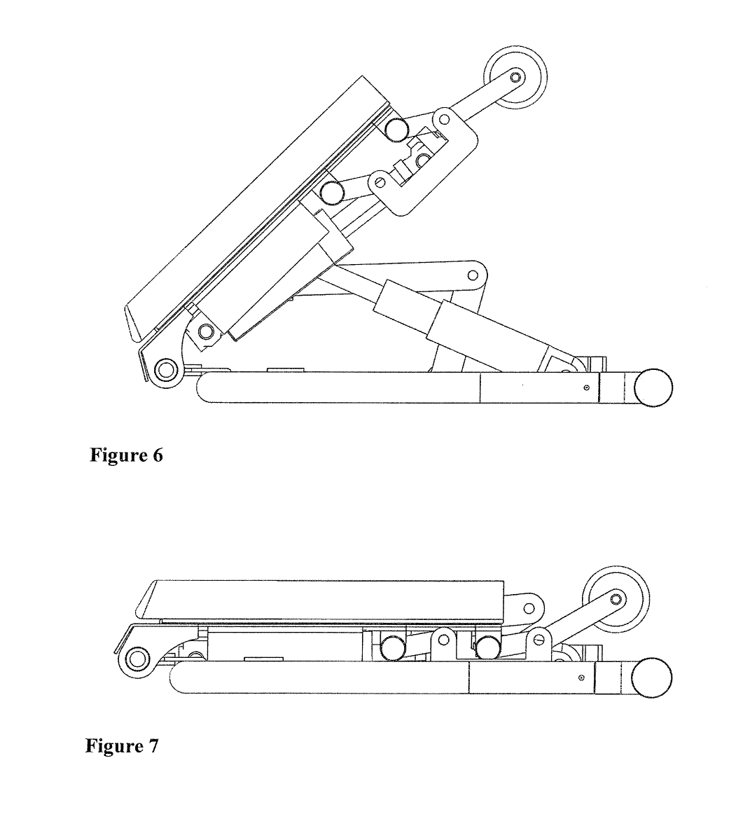

FIGS. 6 to 9 show other embodiments. The Limb Therapy Device aims to enhance the bandaging process, for example for the medical staff providing high compressions bandaging to the lower leg in the treatment of leg ulcers. The foot pedal controlled device lifts and holds the patient's leg in place, leaving both hands of the carer free to perform the bandaging of the lower leg, and therefore not needing an assistant carer to hold the leg in place.

A feature of the device is that it elevates the lower limb by applying pressure to the higher part of the limb section only, leaving the rest of the limb free for treatment.

The device can be regarded as a three piece set: a support frame, an upper limb support and a lower limb support. Both supports have a certain degree of mobility and are controlled by independent actuators, which are controlled by a foot pedal by the user.

At the beginning of the process, the device lays flat on the treatment surface (hospital bed, padded table) and the patient's leg rests on it, with the thigh on the thigh support, and the calf over the lower leg support. Using the foot pedal, the user (care provider) inclines the thigh in order to elevate the knee. When the desired height is reached, the user raises the lower leg using the other foot pedal. Because the lower leg support is short and only covers the highest third of the underside of the lower leg at most, the limb is ready for treatment as it remains uncovered.

Because the device is foot-operated, the leg can be raised and lowered without the use of hands. As most bandages extend to right below the knee in most pressure treatments, it is crucial to uncover the higher part of the calf halfway through the bandaging process. By lowering the lower leg until the patient's heel rests on the table, and the lower leg support uncovers the calf, the care provider can access the whole lower leg without letting go of the bandages as his/her hands are not needed to adjust the device.

The device consists of three major parts: a support frame, a thigh support and a lower leg support. Both supports are mobile and their position is dictated by two independent actuators (FIG. 6).

The thigh support has one side hinged to the support frame. An actuator increases the angle between the thigh support and the horizontal, causing the knee of the patient to rise.

The lower leg support can be fixed to the support frame or directly to the thigh support, as it is for our prototype. It fits neatly under the patient's knee, and should cover about the higher third of his/her calf. Its extension is controlled by an actuator. When at its lowest point, it leaves the patient's calf bare. The lower leg support is then raised and applies pressure onto the patient's higher calf, causing the heel to rise. Some design features were considered for our prototype in order to allow a smooth articulation of the device, to lesser the force concentrations allowing the use of lighter structural material and mainstream actuators; and to suit multiple patient phenotypes.

In FIG. 6 the lower leg support actuator causes the cylinder to extend outwards, applying pressure on the higher section of the patient's calf, and causing the leg to extend. The patient's foot is now suspended above the treatment surface, and is available for treatment.

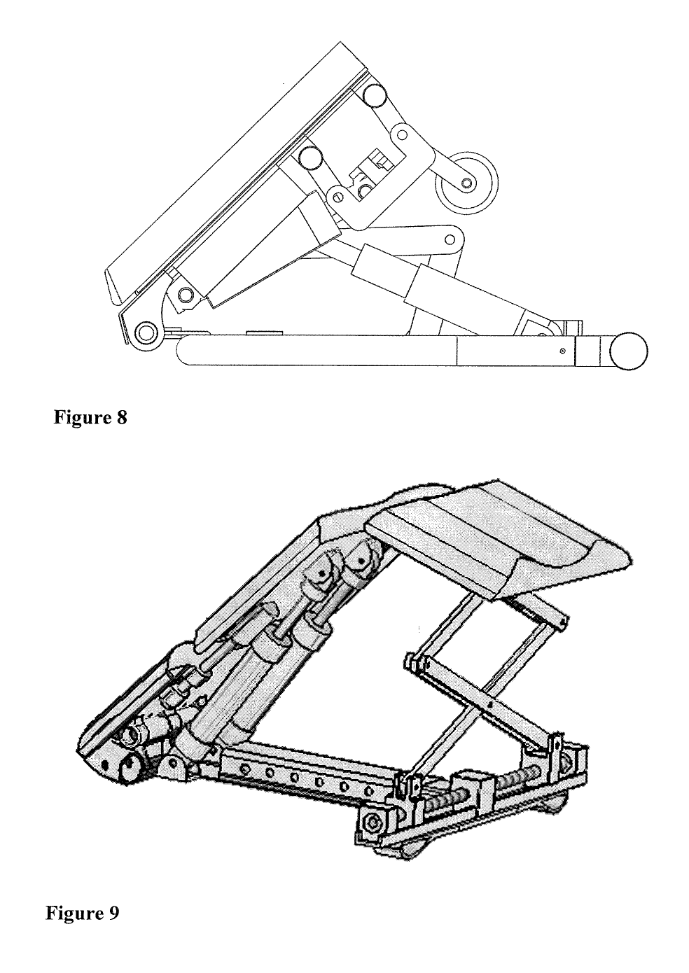

In order to allow the device to be as flat as possible when at rest (FIG. 7), the lower leg support (a cylinder to allow frictionless motion along the calf's length) is attached to the thigh support. In FIG. 7 the device lays flat on a horizontal surface such as a bed or treatment table. The slide allows the lower leg support (right) to be fully extended at rest regardless of the actuator's position in order to allow maximal compactness. A sliding system allows the lower leg support to drop down to its minimum while the thigh support is being inclined in order to keep the patient's leg flexed as the knee is raised, as an unnecessary full extension of the leg could cause some stability issue for the device and discomfort to the patient (FIG. 8). In FIG. 8 the thigh support actuator unfolds the device, the sliding system allows the lower leg support to fall back to its minimum; allowing the heel of the patient to rest on the treatment surface while the knee is being raised. Alternative designs for this device included a scissor lift for the lower leg support (FIG. 9).

The layout of the actuators for both supports allows for optimal stability and force distribution. The thigh support actuator is connected to an articulated arm that allows for a greater stroke (therefore requiring a lesser force) and increases the stability of the device. The lower leg support actuator is mounted on a hinge in order to follow the rotation of the parallelogram support structure of the cylinder.

The ability to extend or shorten the length of the cylinder holders allows a great amplitude in fittings that would suit the vast majority of patients. Other adjustability features such as the thigh support interchangeability to suit different thigh widths is included.

The care provider will find the device useful as it reduces the physical effort needed to lift and maintain the patient's leg in place, while trying to bandage tightly. By preventing awkward lifting that could result in potential back injury, this device also presents an advantage on health and safety for the care provider.

This device was also designed to be as flat and light as possible to be practical in homecare situations, where nurses and carers who often work alone will need to carry the device with them throughout the day

Aside from bringing dignity and comfort to the patient who can be embarrassed to see the care provider struggle due to excessive weight or wounds, the device enhances the quality of the bandaging as it allows the medical staff to focus their energy on the dressing of the leg, and not its support.

Ultimately, because it allows a single person to carry out a task that often needs two or sometimes three people (as obesity and fluid retention are often inherent to the condition resulting in leg ulcers), the cost of the process can be reduced.

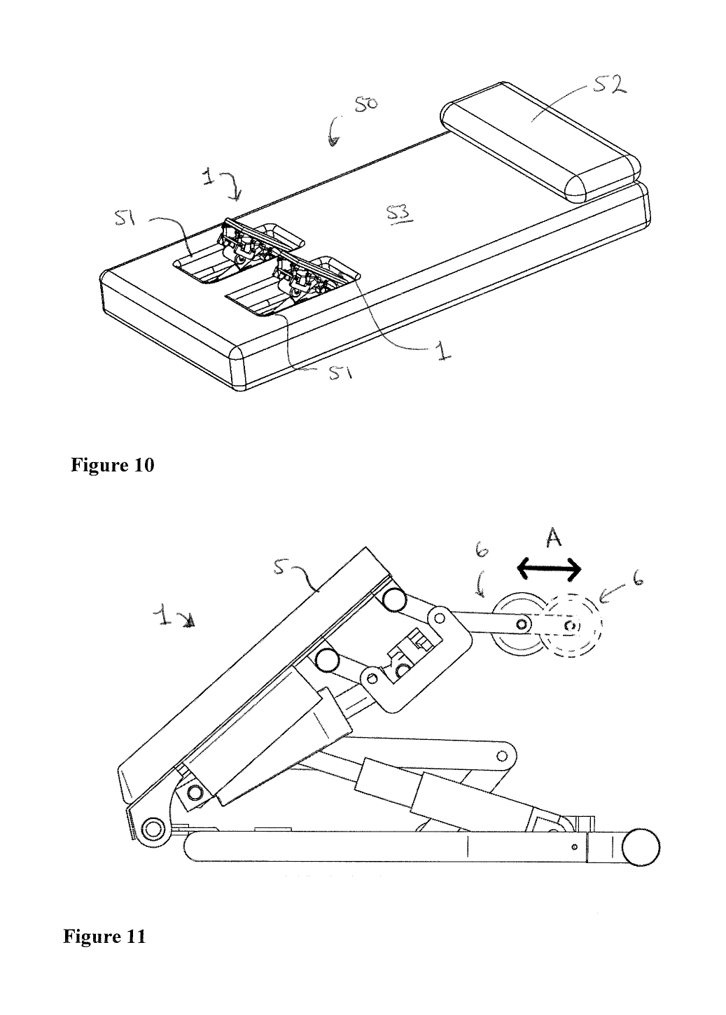

FIG. 10 shows a schematic representation of two devices 1 (of the type shown in earlier drawings) incorporated into a patient support which is in the form of an examination table or bed 50. Each device 1 is recessed into the patient support 50 being located within a recess 51 in the patient support. The patient support 50 has a head support 52.

The device 1 is shown in a raised position but when it is in a lowered configuration it is arranged to be substantially flush with a (top or upper) support surface 53 of the patient support 50.

In the embodiment of FIG. 10 each device is incorporated into the patient support at a position to raise a leg of the patient. It will be appreciated that a single device of the invention could be used and/or a device of the invention could be positioned in a different place in the support for example to allow raising of an arm or the like. As two separate devices of the invention are incorporated into the patient support, each is arranged for raising and lowering one of the left or right legs of a patient. In this respect “separate” means that the functionality for each leg is independently actuable so that each leg may be raised and lowered independently.

It will be appreciated that the device of the invention may be incorporated into any patient support which is suitable for supporting the patient during a treatment, for example incorporated into a seat, examination table or bed.

FIG. 11 is a side view of a device 1 of the invention which is adjustable to accommodate different limb lengths. The device is adjustable to accommodate different sizes of patient. For example the device of the invention may be utilised in a treatment for patients of varying heights.

Generally speaking taller patients will have longer limbs and in general children will be shorter than adults. According to this embodiment of the invention the position of the second part, the lower limb support is adjustable for limbs of different length. As indicated by the double-headed arrow A the lower limb support 6 is length adjustable on the device 1 so that the distance between the lower limb support 6 and the upper limb support 5 may be lengthened to accommodate a relatively longer limb or be shortened to accommodate a relatively shorter limb. This means that the lower limb support 6 can be adjusted to abut and lift a lower limb 32 at a desirable position along that limb to take account of longer and shorter limbs. It will be noted that the adjustment of the lower limb support 6 does not change the operation of the device 1 and the lower limb support 6 is still moveable to a position analogous to that of FIG. 3. it will be appreciated that the greater the distance spanned by the lower limb support 6 and the upper limb support 5 the longer the limb that can be lifted using the device of the invention.

In any of the embodiments of the present invention where it is desired to prevent unwanted movement of the device, the device of the invention may be fitted with non-slip means for example non-sip material for engaging a support on which the device is placed. For example the non-slip material may be a high friction material. Suitable materials are well-known and include elastomers such as rubber. The non-slip material may be provided in the form of a single non-slip pad or alternatively may be provided in the form of at least two discrete pads which are spaced apart from each other for example as feet on the device. The non-slip means may have a physical non-slip profile, for example having raised ribs and/or threads.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A limb support device for supporting a limb of a patient, the limb including an upper limb above a joint and a lower limb below the joint, the device comprising:
(a) a first part for supporting the upper limb but not the lower limb, so that the lower limb can articulate about the joint when the upper limb is being supported by the first part;
(b) a second part arranged for engaging the lower limb only, and for raising and lowering the lower limb by articulation about the joint, so that, while the upper limb is supported by the first part, the second part is moveable between a remote position where it is remote from the lower limb and a position in which it engages the lower limb.

2. A device according to claim 1 wherein the second part engages the lower limb only at an upper region thereof.

3. A device according to claim 1 wherein the upper limb support is moveable between a raised and a lowered position.

4. A device according to claim 1 wherein the second part is carried on the first part.

5. A device according to claim 1 wherein in the remote position the second part is closer to the first part, and in the position where it engages the lower limb, it extends further away from the first part.

6. A device according to claim 1 wherein the device further comprises an actuator for moving the second part to raise the lower limb.

7. A device according to claim 1 wherein the device further comprises an actuator for moving the first part to raise the upper limb.

8. A device according to claim 1 which has at least one configuration where it is substantially flat.

9. A device according to claim 1 which has at least the following three configurations:
(i) a low profile configuration;
(ii) a first raised profile configuration where both the upper limb and lower limb are held in a raised position; and
(iii) a second raised profile configuration where only the upper limb is held in a raised position by the device and the lower limb is free to articulate about its joint so that a lower end of the lower limb can support the lower limb.

10. A device according to claim 1 which has at least the following configurations:
(i) a low profile configuration where it fits under a leg and desirably the leg is substantially straight;
(ii) a first raised profile configuration where both the upper leg and lower leg are held in a raised position so that the foot is in the air; and
(iii) a second raised profile configuration where only the upper leg is held in a raised position by the device and the lower leg is free to articulate about the knee so that the foot supports the lower leg.

11. A system comprising the device of claim 1 together with a control system therefore, the control system for effecting pre-programmed movement within a limb raising sequence of movements.

12. A system according to claim 11 wherein the control system is for effecting preprogrammed movement within a limb raising and limb lowering sequence of movements.

13. A system according to claim 11 wherein the control system is automated to carry out pre-programmed movement in a stepwise fashion.

14. A system according to claim 11 wherein the control system is automated to carry out pre-programmed movement in a stepwise fashion in response to one or more input signals generated by action of a user.

15. A system according to claim 12 wherein the control system is automated to carry out pre-programmed movement in a stepwise fashion.

16. A system according to claim 12 wherein the control system is automated to carry out pre-programmed movement in a stepwise fashion in response to one or more input signals generated by action of a user.
